(19) United States
(12) Patent Application Publication
(10) Pub. No.: US 2022/0246989 A1
(43) Pub. Date: Aug. 4, 2022

(54) STACKED ELECTRODE BODY, RESIN-FIXED STACKED ELECTRODE BODY, AND ALL-SOLID-STATE BATTERY

(71) Applicant: TOYOTA JIDOSHA KABUSHIKI KAISHA, Toyota-shi (JP)

(72) Inventor: Masato ONO, Nagoya-shi (JP)

(21) Appl. No.: 17/544,161

(22) Filed: Dec. 7, 2021

(30) Foreign Application Priority Data
Jan. 29, 2021 (JP) 2021-013502

(51) Int. Cl. H01M 10/0585; H01M 50/14

(52) U.S. Cl. CPC H01M 10/0585; H01M 50/14

(57) ABSTRACT

Provided is a stacked electrode body such that resin is easily applied to a side face thereof. The stacked electrode body for an all-solid-state battery includes a plurality of electrode bodies that are stacked and each include a first electrode, a solid electrolyte layer, a second electrode, and a second current collector which are disposed on each of both surfaces of a first current collector in the order mentioned, wherein each of the electrode bodies has a phase difference portion including the first electrode, the phase difference portion extending further from a side face of the stacked electrode body than the second electrode, and in each adjacent pair of the electrode bodies, a portion of one of the phase difference portions which extends further than the second electrode in the extending direction has a different length from that of the other phase difference portion.

### FIELD

The present application relates to a stacked electrode body, a resin-fixed stacked electrode body, and an all-solid-state battery.

### BACKGROUND

An all-solid-state battery that is safer than an aqueous battery has been developed in recent years. The all-solid-state battery is manufactured as a result of layering a cathode current collector, a cathode, a solid electrolyte layer, an anode, and an anode current collector. The following technique is also known: when the all-solid-state battery is manufactured, these layers are fixed with resin to improve mechanical strength of the battery and resistance thereof to moisture penetration.

For example, Patent Literature 1 discloses a method for manufacturing an all-solid-state battery which comprises a first step of layering a plurality of current collector layers, cathode mixture layers, solid electrolyte layers and anode mixture layers and thus obtaining a stacked battery provided with both end surfaces in the stacking direction and a side surface; a second step of supplying a liquid resin only to the side surface of the stacked battery; and a third step of curing the liquid resin, wherein in the first step, at least one kind of the current collector layers, the cathode mixture layers, the solid electrolyte layers and the anode mixture layers is extended to form extending layers, and as a result a plurality of the extending layers are extended on the side surface of the stacked battery; and in the second step, the supply of the liquid resin only to the side surface of the stacked battery allows the liquid resin to enter spaces among one and other extending layers. Patent Literature 1 also discloses, as techniques for allowing the liquid resin to enter the spaces, a technique of providing a pressure reducing step between the first and second steps, and a technique of providing a pressure applying step between the second and third steps.

### CITATION LIST

### Patent Literature

Patent Literature 1: JP 2017-220447 A
Patent Literature 2: JP 2014-523102 A
Patent Literature 3: JP 2000-124057 A

### SUMMARY

### Technical Problem

The techniques according to Patent Literature 1 are for fixing the side surface of the stacked battery having a plurality of the extending layers (phase difference portions) with the resin, which are provided with the pressure applying step or the pressure reducing step for allowing the resin to sufficiently enter the spaces among the extending layers. In view of firmly fixing the stacked battery having the phase difference portions, the spaces among the phase difference portions are desirably filled with the resin. However, it is difficult to fill the spaces with the resin sufficiently deep under too low pressure; and the resin may escape to an electrode reaction face under too high pressure. Therefore, the pressure applying step or the pressure reducing step performed when the resin is applied to the side surface of a stacked electrode body having the phase difference portions makes it difficult to control shaping of the resin, which is problematic.

With the foregoing actual circumstances in view, a major object of the present disclosure is to provide a stacked electrode body such that resin is easily applied to a side face thereof.

### Solution to Problem

The present disclosure is provided with, as one means for solving the above problems, a stacked electrode body for an all-solid-state battery which includes a plurality of electrode bodies that are stacked and each include a first electrode, a solid electrolyte layer, a second electrode, and a second current collector which are disposed on each of both surfaces of a first current collector in the order mentioned, wherein each of the electrode bodies has a phase difference portion including the first electrode, the phase difference portion extending further from a side face of the stacked electrode body than the second electrode, and in each adjacent pair of the electrode bodies, a portion of one of the phase difference portions which extends further than the second electrode in an extending direction has a different length from that of the other phase difference portion.

In the stacked electrode body, lengths of portions of the phase difference portions which extend further than the second electrodes, may be increasing or decreasing stepwise from one to the other sides in the stacking direction, and may be increasing or decreasing stepwise from the center to outsides of the stacked electrode body in the stacking direction.

The present disclosure is provided with a resin-fixed stacked electrode body formed by fixing the side face of the stacked electrode body with resin. The present disclosure is also provided with an all-solid-state battery having the resin-fixed stacked electrode body.

### Advantageous Effects

In the stacked electrode body according to the present disclosure, the portion of one of the phase difference portions, which extends further than the second electrode in the extending direction, (extending portion) has a different length from that of the other phase difference portion. That is, adjacent phase difference portions form steps. Therefore, the resin is easily applied to a side face of the stacked electrode body. For example, the side face has a shape capable of applying the resin thereto without pressure obliquely applied. In addition, it is not necessary to apply the resin to the stacked electrode body according to the present disclosure under pressure or reduced pressure unlike Patent Literature 1, which suppresses an escape of the resin to an electrode reaction face, and also suppresses misregistration of electrodes when the resin is applied to the side face. Further, the resin capable of being easily applied to a side face of the stacked electrode body suppresses the risk of short circuits due to powder falling from a side face of electrodes after the resin is fixed.

It seems to be difficult to position the stacked electrode body according to the present disclosure because the lengths of the extending portions are different between adjacent phase difference portions. However, the external shape of the stacked electrode body can be controlled by the application of the resin. For example, the resin is applied in such a way that the external shape becomes a quadrilateral, which makes the stacked electrode body more easily positioned.

Patent Literatures 2 and 3 describe a stacked electrode body provided with steps made of electrode bodies of different sizes. Such a stacked electrode body does not have the phase difference portion as the stacked battery according to Patent Literature 1. Thus, it is believed that the above-described problem does not arise from electrode bodies according to Patent Literatures 2 and 3.

### BRIEF DESCRIPTION OF DRAWINGS

FIG. 1 is a perspective view of a stacked electrode body 100;

FIG. 2 is a cross-sectional view of the stacked electrode body 100;

FIG. 3 is a cross-sectional view of a stacked electrode body 100′;

FIG. 4 is a cross-sectional view of resin-fixed stacked electrode bodies 200 and 200′;

FIG. 5 is a schematic view of each electrode body after a cutting step is completed; and

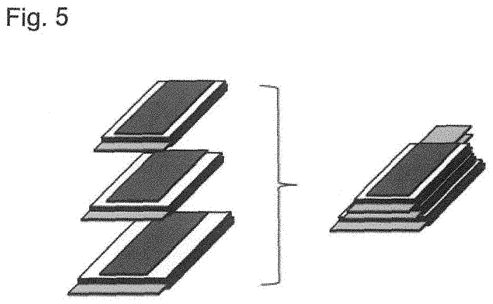

FIGS. 6A to 6D show scenes of a resin fixing step.

### DESCRIPTION OF EMBODIMENTS

[Stacked Electrode Body]

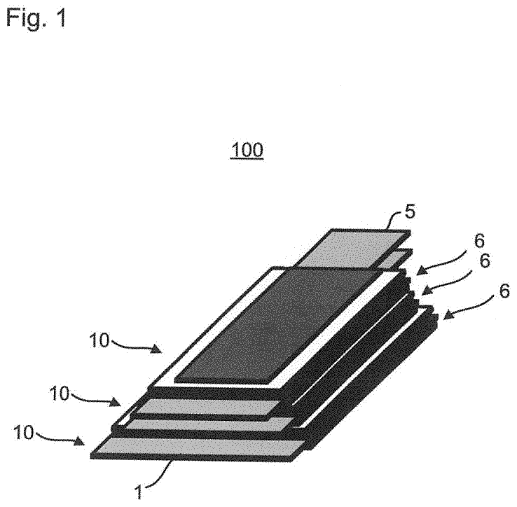

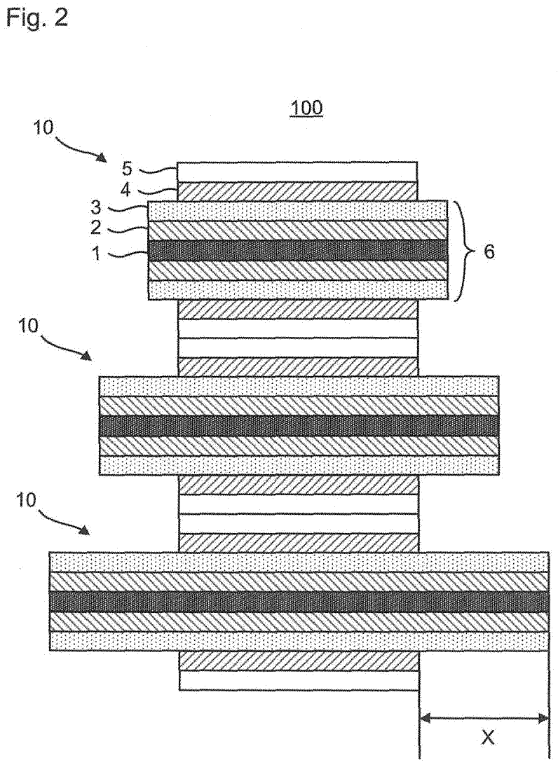

A stacked electrode body according to the present disclosure will be described with reference to a stacked electrode body 100 that is one embodiment. FIG. 1 is a perspective view of the stacked electrode body 100. FIG. 2 is a cross-sectional view of the stacked electrode body 100.

As shown in FIG. 2, the stacked electrode body 100 is a stacked electrode body for all-solid-state batteries which includes a plurality of the electrode bodies 10 that are stacked and each include a first electrode 2, a solid electrolyte layer 3, a second electrode 4, and a second current collector 5 which are disposed on each of both surfaces of a first current collector 1 in this order. FIGS. 1 and 2 show the stacked electrode body 100 including three stacked electrode bodies 10. The number of the stacked electrode bodies 10 is not particularly limited.

Each of the electrode bodies 10 has a phase difference portion 6 including the first electrodes 2. Layers having portions extending further than side faces of the second electrodes 4 are collectively referred to as a phase difference portion. In FIG. 2, the layers of the first current collector 1, the two first electrodes 2 and the two solid electrolyte layers 3 together (layers held by the solid electrolyte layer 3 on one side and the solid electrolyte layer 3 on the other side in the stacking direction) are collectively referred to as the phase difference portion 6.

Here, the stacked electrode body 100 (electrode bodies 10) has both end surfaces in the stacking direction and side faces. “Side faces” are faces formed of the outer edges of the stacked electrode body 100 (electrode bodies 10). The phase difference portion 6 may be provided on any of the side faces. When a current collector extends from a side face for connecting with an electrode terminal, the phase difference portion 6 is preferably provided on a side face different from that where the current collector extends because, as described later, a side face provided with the phase difference portion 6 is fixed with resin.

The phase difference portion 6 as described above is provided on the electrode body 10 because of short circuit prevention due to Li precipitation. The first electrodes 2 extend further than the second electrodes 4 on side face sides for enhancing effectiveness of the foregoing. In more detail, the area of the first electrodes 2 is designed to be larger than that of the second electrodes, so that the second electrodes 4 are disposed inside the outer edges of the first electrodes 2. In FIG. 2, the first current collector 1 and the solid electrolyte layers 3 are included in the phase difference portion because adjusted to the shapes of the first electrodes 2.

Here, portions of the phase difference portion 6 which extend further than the second electrodes 4 are referred to as extending portions. The lengths X of the extending portions in the extending direction (see FIG. 2) are each in the range of, for example, 0.1 mm and 10 mm. In the stacked electrode bodies 10, the length of the longest extending portion in the extending direction is preferably in the range of 1 mm and 10 mm, and more preferably in the range of 2 mm and 5 mm; and the length of the shortest extending portion in the extending direction is preferably in the range of 1 mm and 2 mm, and more preferably in the range of 0.5 mm and 1 mm.

Next, each of the electrode bodies 10 will be compared. In adjacent electrode bodies 10, there is a space between one and the other phase difference portions 6, and the lengths of the portions extending further than the second electrodes (extending portion) in the extending direction is different between the one and the other phase difference portions 6. In each of the electrode bodies 10, the sizes of the second electrodes 4 are preferably equal to each other.

The respective electrode bodies 10 have the phase difference portions 6, and thus, spaces are present among these phase difference portions 6. In the stacked electrode body 100, the lengths of the extending portions of the phase difference portions 6 in the extending direction are different between adjacent electrode bodies 10. In other words, adjacent phase difference portions 6 form steps.

Adjacent phase difference portions 6 forming steps as described above make it easy to apply resin to a side face of the stacked electrode body 100. For example, the side face has a shape capable of applying resin thereto without pressure obliquely applied. In addition, it is not necessary to apply resin to the stacked electrode body 100 under pressure or reduced pressure, which suppresses an escape of the resin to an electrode reaction face, and also suppresses misregistration of electrodes when the resin is applied to the side face. Further, the resin capable of being easily applied to a side face of the stacked electrode body suppresses the risk of short circuits due to powder falling from a side face of electrodes after the resin is fixed.

The difference between the lengths X of the extending portions of adjacent phase difference portions 6 in the extending direction is, for example, in the range of 0.01 mm and 1 mm, and preferably in the range of 0.1 mm and 0.5 mm. The size of a space between the phase difference portions 6 is determined by the configuration of the electrode bodies 10.

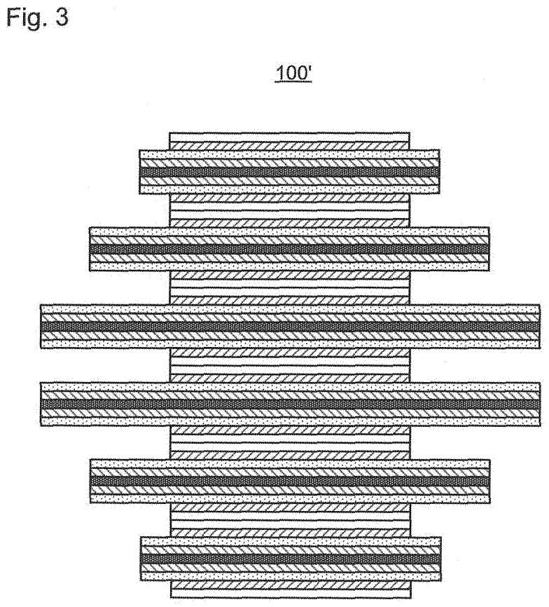

Next, the shape of the entire stacked electrode body 100 will be described. FIG. 2 shows an example of the stacked electrode body 100 such that the lengths of the extending portions of the phase difference portions 6 in the extending direction are increasing or decreasing stepwise from one to the other side in the stacking direction. FIG. 3 shows an example of a stacked electrode body 100′ such that the lengths of the extending portions of the phase difference portions 6 in the extending direction are increasing or decreasing stepwise from the center to the outsides in the stacking direction. The shape of the stacked electrode body 100 is not limited to these examples as long as the lengths of the extending portions of adjacent phase difference portions 6 in the extending direction are different.

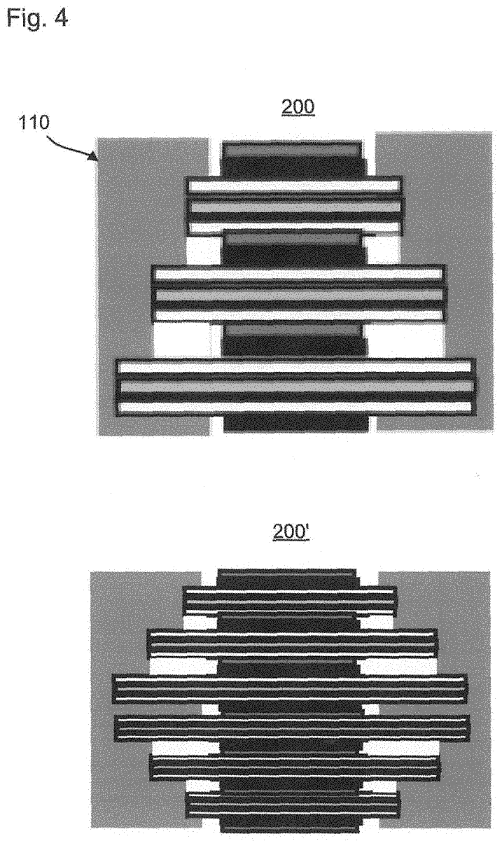

It seems to be difficult to position the stacked electrode body 100 when the battery is housed in a predetermined case because the lengths of the extending portions are different between adjacent phase difference portions 6. However, the external shape of the stacked electrode body can be controlled by application of resin as described later. Thus, the stacked electrode body 100 can be positioned more easily. For example, resin is applied in such a way that the external shape becomes a quadrilateral, which makes the stacked electrode body 100 more easily positioned (see FIG. 4).

Hereinafter each component constituting the electrode body 10 will be described.

<First Current Collector 1 and Second Current Collector 5>

One of the first current collector 1 and the second current collector 5 is a cathode current collector, and the other is an anode current collector. Here, in the electrode body 10, one sheet may form one layer of each current collector, or a plurality of sheets may be superposed to form one layer thereof. One and another of the electrode bodies 10 may share one layer of any current collector.

As the cathode current collector, metal foil such as SUS, Ni, Cr, Al, Pt, Fe, Ti and Zn may be used. A carbon coating may be disposed on the surface of the cathode current collector. The thickness of the carbon coating ranges, for example, from 1 μm to 20 μm. The material of the carbon coating includes carbon and a binder.

As the anode current collector, metal foil such as SUS, Cu, Ni, Fe, Ti, Co and Zn may be used.

<First Electrode 2 and Second Electrode 4>

One of the first electrode 2 and the second electrode 4 is a cathode, and the other is an anode. Specifically, when the first current collector 1 is an anode current collector, the first electrode 2 is an anode, and when the first current collector 1 is a cathode current collector, the first electrode 2 is a cathode. Similarly, when the second current collector 5 is an anode current collector, the second electrode 4 is an anode, and when the second current collector 5 is a cathode current collector, the second electrode 4 is a cathode. Preferably, the first electrode 2 is an anode and the second electrode 4 is a cathode in view of short circuit prevention due to Li precipitation.

The cathode contains at least a cathode active material. As the cathode active material, a known cathode active material that may be used for lithium ion all-solid-state batteries can be given, and examples thereof include lithium cobaltate.

The cathode may contain a solid electrolyte. As the solid electrolyte, a known solid electrolyte may be used, and examples thereof include oxide solid electrolytes and sulfide solid electrolytes. Sulfide solid electrolytes are preferable. As sulfide solid electrolytes, Li₂S—P₂S₅ and the like can be given. The ratio of Li₂S to P₂S₅ in Li₂S—P₂S₅ is, for example, within the range such that Li₂S:P₂S₅=50:50 to 100:0, which is preferably 50:50 to 90:10. The cathode may contain a binder. As the binder, a known binder may be used, and examples thereof include fluorine containing resins such as polyvinylidene fluoride (PVdF). The cathode may contain a conductive material. As the conductive material, a known conductive material may be used, and examples thereof include acetylene black and vapor grown carbon fibers (VGCF).

The thickness of the cathode is not particularly limited, but is, for example, in the range of 0.1 μm and 1000 μm. The content of each constituent in the cathode may be the same as in conventional cathodes.

The anode contains at least an anode active material. As the anode active material, a known anode active material that may be used for lithium ion all-solid-state batteries can be given, and examples thereof include known carbon materials such as graphite.

The anode may contain a solid electrolyte. As the solid electrolyte, a known solid electrolyte may be given, and examples thereof include the above described solid electrolytes, which may be used for the cathode. The anode may contain a binder. As the binder, a known binder can be given, and examples thereof include the above described binders, which may be used for the cathode. The anode may contain a conductive material. As the conductive material, a known conductive material can be given, and examples thereof include the above described conductive materials, which may be used for the cathode.

The thickness of the anode is not particularly limited, but is, for example, in the range of 0.1 μm and 1000 μm. The content of each constituent in the anode may be the same as in conventional anodes.

<Solid Electrolyte Layer 3>

The solid electrolyte layer 3 contains a solid electrolyte. As the solid electrolyte, a known solid electrolyte that may be used for lithium ion all-solid-state batteries can be given, and examples thereof include the above described solid electrolytes, which may be used for the cathode.

The solid electrolyte layer 3 may contain a binder. As the binder, a known binder can be given, and examples thereof include the above described binders, which may be used for the cathode, and butadiene rubber.

The thickness of the solid electrolyte layer 3 is not particularly limited, but is, for example, in the range of 0.1 μm and 1000 μm, and preferably in the range of 0.1 μm and 300 μm. The content of each constituent in the solid electrolyte layer 3 may be the same as in conventional solid electrolyte layers.

[Resin-Fixed Stacked Electrode Body]

A resin-fixed stacked electrode body according to the present disclosure is formed by fixing a side face of the above described stacked electrode body with resin. FIG. 4 shows resin-fixed stacked electrode bodies 200 and 200′ that are resin-fixed stacked electrode bodies. In FIG. 4, resin is denoted by 110. A side face of the stacked electrode body are fixed with resin as described above in order to suppress misregistration in stacking and in order to suppress short circuits due to foreign matters formed by powder falling from end surfaces of electrodes.

Any side face(s) of the stacked electrode body may be fixed with resin. The side face(s) preferably include(s) at least a side face having any of the phase difference portions. Alternately, all the side faces may be fixed with resin. It is not always necessary to fill the spaces among the phase difference portions with resin because it is sufficient to fix only a side face of the stacked electrode body with resin.

Either a thermosetting resin or a photo-curable resin may be used as the resin used for the resin-fixed stacked electrode body. A photo-curable resin is preferably used.

[All-Solid-State Battery]

An all-solid-state battery according to the present disclosure has the above described stacked electrode body or resin-fixed stacked electrode body, preferably the resin-fixed stacked electrode body. The all-solid-state battery according to the present disclosure may have a case for housing the stacked electrode body or resin-fixed stacked electrode body, any other necessary terminals, etc.

[Method of Manufacturing Stacked Electrode Body, Resin-Fixed Stacked Electrode Body and All-Solid-State Battery]

A method of manufacturing the stacked electrode body, resin-fixed stacked electrode body, and all-solid-state battery according to the present disclosure will be described. Hereinafter a method of manufacturing the all-solid-state battery will be described as a comprehensive manufacturing method for them. The method of manufacturing the all-solid-state battery includes a preparation step, a layering step, a cutting step, an electrode bodies stacking step, a resin fixing step, and a housing step.

<Preparation Step>

In the preparation step, a cathode, a solid electrolyte layer, and an anode are each prepared. These may be prepared according to known methods without any particular limitations. For example, when a cathode is prepared, a material to constitute the cathode is mixed with a solvent to form a slurry. Next, the slurry is applied onto a substrate or a cathode current collector and dried. Then, the cathode can be obtained. A solid electrolyte layer and an anode may be prepared according to the same method.

<Layering Step>

The layering step is a step of layering the cathode current collector, the cathode, the solid electrolyte layer, the anode and an anode current collector. In the layering step, for example, the anode, the solid electrolyte layer, the cathode, and the cathode current collector are layered on each of both surfaces of the anode current collector in that order. This is the layering order when the first current collector is the anode current collector, the first electrode is the anode, the second current collector is the cathode current collector, and the second electrode is the cathode in the above described electrode body. The layering order is not limited to this. The cathode, the solid electrolyte layer, the anode, and the anode current collector may be layered on each of both surfaces of the cathode current collector in that order. This is the layering order when the first current collector is the cathode anode current collector, the first electrode is the cathode, the second current collector is the anode current collector, and the second electrode is the anode in the above described electrode body. Each component may be layered according to a known method.

In the layering step, after the electrode components are layered, this layered body may be, for example, pressed in order to enhance adhesiveness of each layer. The pressing pressure is, for example, approximately 600 MPa.

<Cutting Step>

The cutting step is a step of cutting the phase difference portions of the layered bodies prepared in the layering step for differentiating the lengths of the extending portions of the phase difference portions of adjacent electrode bodies in the extending direction. For example, as in FIG. 4, the phase difference portions of the layered bodies are cut so as to form steps from one to the other sides in the stacking direction. The phase difference portion to have the longest extended portion in the stacked electrode body is not necessary to be cut in the cutting step. Each electrode body to constitute the stacked electrode body is prepared in the cutting step. For example, a known laser cutter is preferably used in the cutting step because laser cutting makes it possible to suppress cracking of electrodes to perform good cutting.

Here, the phase difference portions are cut in the cutting step because cutting the other portions may lead to decrease in energy density. In other words, it can be said that cutting the phase difference portions in the cutting step to differentiate the lengths of the extending portions of adjacent phase difference portions in the extending direction can suppress decrease in energy density.

<Electrode Bodies Stacking Step>

The electrode bodies stacking step is a step of stacking the prepared electrode bodies. The stacked electrode body is prepared according to the electrode bodies stacking step. The method for stacking the electrode bodies is not particularly limited, but is, for example, carried out as follows. First, an adhesive is applied to current collectors disposed on outer sides of electrode bodies in the stacking direction (second current collectors), and the electrode bodies are stacked. Then the stacked electrode body is, for example, pressed for enhancing the adhesiveness. At this time, the stacked electrode body may be heated and pressed. For example, the pressing pressure is 1 MPa and the temperature is approximately 140° C.

Here, each electrode body is checked for misregistration when stacked. The checking method is such that the center of the cathode is calculated as viewed from the top surface in the stacking direction, and each electrode body is checked for misregistration on the basis of this center. The checking method may be performed, for example, according to a known imaging examination.

<Resin Fixing Step>

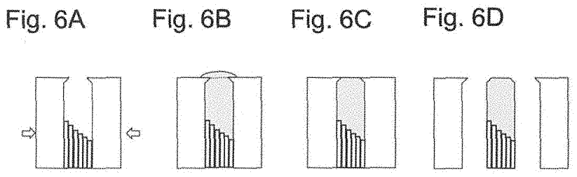

The resin fixing step is a step of fixing a side face of the prepared stacked electrode body with resin. The resin-fixed stacked electrode body is prepared according to the resin fixing step. FIGS. 6A to 6D show scenes of the resin fixing step.

First, as in FIG. 6A, a mold is fixed to the stacked electrode body in such a manner that the mold follows thickness change of the stacked electrode body. At this time, pressure is applied to the mold as long as the spaces among the electrodes are minimized and the electrodes are not damaged. When the strength of the mold is weaker than the electrodes strength, pressure such as not to lead to deformation of the mold is the upper limit. The material of the mold may be a material having good releasability, and examples thereof include fluororesin. Next, as in FIG. 6B, a space surrounded by the mold and the stacked electrode body on a side face side of the stacked electrode body is filled with resin. Next, as in FIG. 6C, an excessive portion of the resin with which the mold overflows is scraped off with, for example, a scraper, and the resin is cured. When a thermosetting resin is used, the resin is heated. When a photo-curable resin is used, the resin is irradiated with UV. As in FIG. 6D, the mold is removed last.

<Housing Step>

The housing step is a step of housing the prepared stacked electrode body or resin-fixed stacked electrode body in a predetermined case. The all-solid-state battery can be manufactured according to the housing step. In the housing step, terminals etc. necessary for the stacked electrode body or resin-fixed stacked electrode body may be connected.

As described above, the stacked electrode body, resin-fixed stacked electrode body and all-solid-state battery according to the present disclosure, and the manufacturing methods thereof have been described. The present disclosure can be provided with a stacked electrode body such that resin is easily applied to a side face thereof, and a resin-fixed stacked electrode body and an all-solid-state battery which use the electrode body.

### REFERENCE SIGNS LIST

1 first current collector
2 first electrode
3 solid electrolyte layer
4 second electrode
5 second current collector
6 phase difference portion
10 electrode body
100, 100′ stacked electrode body
110 resin
200, 200′ resin-fixed stacked electrode body

What is claimed is:

1. A stacked electrode body for an all-solid-state battery, the stacked electrode body including a plurality of electrode bodies that are stacked, the electrode bodies each including a first electrode, a solid electrolyte layer, a second electrode, and a second current collector which are disposed on each of both surfaces of a first current collector in an order mentioned, wherein
each of the electrode bodies has a phase difference portion including the first electrode, the phase difference portion extending further from a side face of the stacked electrode body than the second electrode, and
in each adjacent pair of the electrode bodies, a portion of one of the phase difference portions, the portion extending further than the second electrode in an extending direction, has a different length from that of another one of the phase difference portions.

2. The stacked electrode body according to claim 1, wherein
lengths of portions of the phase difference portions, the portions extending further than the second electrodes, are increasing or decreasing stepwise from one to another sides in the stacking direction.

3. The stacked electrode body according to claim 1, wherein
lengths of portions of the phase difference portions, the portions extending further than the second electrodes, are increasing or decreasing stepwise from a center to outsides of the stacked electrode body in the stacking direction.

4. A resin-fixed stacked electrode body formed by fixing a side face of the stacked electrode body according to claim 1 with resin.

5. An all-solid-state battery having the resin-fixed stacked electrode body according to claim 4.
